(19) United States
(12) Patent Application Publication
(10) Pub. No.: US 2007/0242869 A1
(43) Pub. Date: Oct. 18, 2007

(54) Processing and measuring the spine in radiographs

(75) Inventors: Hui Luo, Rochester, NY (US); Xiaohui Wang, Pittsford, NY (US); David H. Foos, Rochester, NY (US)

Correspondence Address: EASTMAN KODAK COMPANY;PAMELA R. CROCKER, PATENT LEGAL STAFF, ROCHESTER, NY, 14650-2201, US

(73) Assignee: Eastman Kodak Company

(21) Appl. No.: 11/402,749

(22) Filed: Apr. 12, 2006

(51) Int. Cl. G06K 9/00

(52) U.S. Cl. 382/132

(57) ABSTRACT

An image processing method for automatically analyzing the spine in a radiograph. The methods includes the steps of acquiring the radiographic image in digital form; detecting the spine midline in the radiograph, locating vertebra and pedicle along the spine midline, and calculating geometrical data of the spine in the radiograph.

### FIELD OF THE INVENTION

The invention relates generally to image processing techniques for detecting the spine in a radiograph, and more particularly to techniques for automatically processing the spine and measuring geometrical features of the spine for spine diagnosis.

### BACKGROUND OF THE INVENTION

Scoliosis occurs in the general population, with some statistics approximating an occurrence of 2% of women and ½% of men. Scoliosis is a three-dimensional spine deformity most visible as a lateral spinal curvature and associated with asymmetry of the trunk and rib cage. If scoliosis is neglected, the curves may progress dramatically, creating significant physical deformity and even cardiopulmonary problems.

Radiographic screening is one well known means to examine scoliosis. The radiographic assessment of the scoliosis patient generally comprises erect anteroposterior (AP) and lateral view (LAT) of the entire spine. The scoliotic curve can be measured from the AP view using the Cobb angle method, a commonly used method by the Scoliosis Research Society. The degree of the angle can assist the doctor in estimating the progression of a curve, assessing the need for treatment and the effectiveness of treatment. Currently, the measurement is performed manually by radiologists. However, some studies have shown that the measured angles differ significantly between observers. Such highly observer-dependent variations in diagnosis can result in serious impacts on the treatment planning.

With the advances of digital radiography, the entire spine can be imaged, stored, and displayed digitally in one radiograph. For example, U.S. Pat. No. 6,895,106 (Wang), commonly assigned, is directed to a method for stitching partial radiation image to reconstruct a full image, and automatic and image stitching methods for full-spine and full-leg imaging with computed radiography are disclosed in Proc. SPIE 5368, p 361-369, 2004. Such methods provide opportunities to design faster and more accurate computerized techniques for scoliosis evaluation.

Some commercially available PACS workstations, employed for reviewing digital radiography images, provide semi-automated methods for assessing spine geometric deformity. In one arrangement, while using the PACS workstation, the radiologists or orthopedic surgeons can use the computer input means (such as a computer mouse) to manually draw lines on the workstation display. The workstation then automatically calculates the Cobb angle value based on the defined lines. Although this operation helps reduce the measurement variability by eliminating the use of a protractor, the manual definition of lines are still needed and would introduces bias.

To date, some efforts have been pursued for automatic detection of vertebra, endplates and pedicle for spine analysis, and measuring the geometrical data of the spine in radiographs.

U.S. Pat. No. 6,724,924 (Wei), entitled BRIGHTNESS AND CONTRAST INVARIANT DETECTION OF VERTEBRA PEDICLES, references two methods: one is an evidence-reasoning method for detecting endplate in a radiograph by using both local image data and global knowledge, and the other is a learning-based method for pedicle detection based on an intensity curvature map of the radiograph.

U.S. Application Publication No. 2002/0136437 (Gerard), entitled METHOD AND SYSTEM FOR EXTRACTING SPINE GEOMETRICAL DATA, is directed to a method to extract the spine outlines, the spine endplate and the corners of vertebrae in an x-ray image. As best understood, users initially specify two end points for the spine, and then manually estimate a centerline of the spine. Based on the centerline, a 2D-image band is constructed around the spine region. The image data in the 2D-image band is then processed to determine the spine outlines. Using the spine outline, the endplate and the corners of the vertebra are located by integrating the gradient of the image and the prior knowledge.

U.S. Pat. No. 6,850,635 (Gerard), entitled METHOD AND SYSTEM FOR EXTRACTING SPINE FROUNTAL GEOMETRICAL DATA INCLUDING VERTEBRA PEDICILE LOCATIONS, is directed to an image processing method for extracting spine frontal geometrical data of a spine image by using vertebra and pedicle locations. The method assumes the corner landmarks of a vertebra have already been located in a PA view image. Based on these landmarks, the left and right pedicle of the vertebra can be extracted by computing the lowest state costs and the minimum path costs connecting the pedicles of all vertebras of the spine.

A disadvantage to the above-mentioned methods is that the initial position of the spine needs to be manually defined, which causes inefficiency during execution. Defining the spine position could take more time than directly drawing lines on the workstations for measuring the geometrical angle on a radiograph.

U.S. Application Publication No. 2003/0215122 (Tanaka), entitled MEDICAL IMAGE PROCESSING APPARATUS WITH A FUNCTION OF MEASUREMENT ON A MEDICAL IMAGE, is directed to a method to determine a smooth line along the spine in the medical image, and then calculate a bow scale of the spine based on the smooth line. As the method is best understood by Applicant, the smooth line can be either drawn by the operator or automatically constructed by connecting centers of vertebras, which are extracted by pattern recognition techniques based on the operator specified regions. Because of the variation of the vertebra, especially the significant difference of vertebra between the thoracic spine and the lumber spine, extracting the edge of vertebra can be difficult. Therefore, the resulting smooth line would not accurately represent the spine.

U.S. Pat. No. 6,249,590 (Young), entitled METHOD FOR AUTOMATICALLY LOCATING IMAGE PATTERN IN DIGITAL IMAGES, is directed to a method for vertebrae detection. This method detects a sample of the vertebras, which may not sufficient for accurately assessing the complete geometric deformity of the spine.

Another issue associated with the spine diagnosis is how to render/process a spine radiograph with diagnostic desired quality. Generally, a spine image is stitched from two or three radiographs, and the anatomies in the radiographs present varying thickness, which would result in a wide range of x-ray intensities for image display. Therefore, wedge filter is commonly used by technologists to pre-compensate the x-ray intensity in order to achieve more equalized x-ray exposure on the image receptor (screen-film or digital detector). However, the dynamic range of the resultant image can still be too large to be displayed in proper contrast and brightness across the whole image region. Consequently, some regions of the spine may be rendered too bright, while the others may be too dark, which makes it difficult for visualization and diagnosis. Applicants note that detecting the spine can help address this problem. For example, the image pixel values can be equalized along the spine such that the whole spine can be rendered with similar brightness and contrast.

Accordingly, there exists a need for a method to automatically detect the spine in a radiographic image. Such a method should be robust and suited to accommodate large variations in radiographs

### SUMMARY OF THE INVENTION

The object of the present invention is to provide an automated method for detecting the spine in a radiographic image.

Another object of the present invention is to provide a method for measuring geometrical features of the spine in order to study the spine deformities.

Yet a further object of the present invention is to provide a method to render the desired image look for spine diagnosis.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the present invention, there is provided a method for analyzing a spine in a radiograph. The method includes the steps of: accessing a digital radiographic image; detecting a spine midline in the digital radiographic image; locating vertebras and pedicles in the spine; and calculating geometrical data of the spine.

The step of detecting the spine midline includes preprocessing the radiograph, transforming the radiograph, and detecting the spine midline in the transformed image. If desired, the radiograph can be processed based on the features extracted from the spine midline, in order to achieve the optimal image quality for diagnosis. The step of locating vertebra and pedicle integrates image processing, pattern recognition, and knowledge-based reasoning. The step of calculating geometrical data of the spine is accomplished by computing a plurality of measurements, such as the Cobb angle, Ferguson angle, the rotation angle of a vertebra around its axis, or the like. These measurements can assist a radiologist or orthopedic surgeon in evaluating the spine deformity.

According to another aspect of the present invention, there is provided a method for automatically analyzing the spine in a radiographic image. The method includes the steps of: accessing the radiographic image in digital form; detecting the spine midline of the digital image; locating a plurality of key landmarks for each vertebra and pedicle in the spine; and calculating a plurality of geometrical data of the spine to assist the evaluation of the spine deformity.

According to a further aspect of the present invention, there is provided a method for automatically processing a spine radiographic image. The method includes the steps of: accessing the radiographic image in digital form; detecting the spine midline of the digital image; and processing the radiograph according to the features extracted from the spine midline in order to render a diagnostically satisfactory image look.

### BRIEF DESCRIPTION OF THE DRAWINGS

The foregoing and other objects, features, and advantages of the invention will be apparent from the following more particular description of embodiments of the invention, as illustrated in the accompanying drawings. The elements of the drawings are not necessarily to scale relative to each other.

FIGS. 1A-1B show flow charts in accordance with a method of the present invention.

FIG. 2 is a flow chart illustrating a method for detecting the spine midline in a radiograph in accordance with the present invention.

FIGS. 3A-3C show diagrammatic views illustrating the detecting of the spine midline, wherein FIG. 3A displays an original image, FIG. 3B shows the derivative image used for detecting the midline, and FIG. 3C depicts the extracted spine midline.

FIG. 4 shows a diagrammatic view illustrating the construction of the region of interest (ROI).

FIG. 5 shows a flow chart illustrating a method for processing a spine radiograph.

FIG. 6 shows a block diagram illustrating the steps of using active shape model for the vertebra detection.

FIG. 7 shows a flow chart illustrating a method for calculating the Cobb angle.

FIG. 8 shows a graphic overlay of the measured Cobb angle on top of a spine image.

### DETAILED DESCRIPTION OF THE INVENTION

The following is a detailed description of the preferred embodiments of the invention, reference being made to the drawings in which the same reference numerals identify the same elements of structure in each of the several figures.

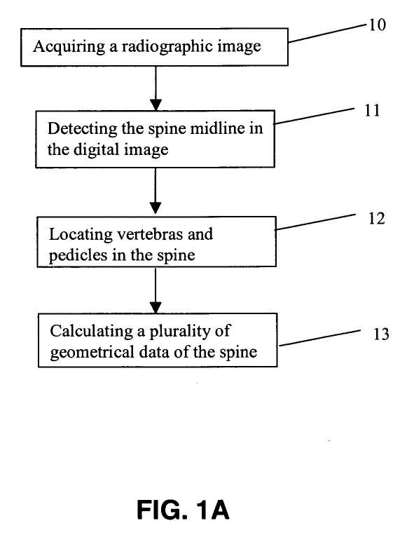

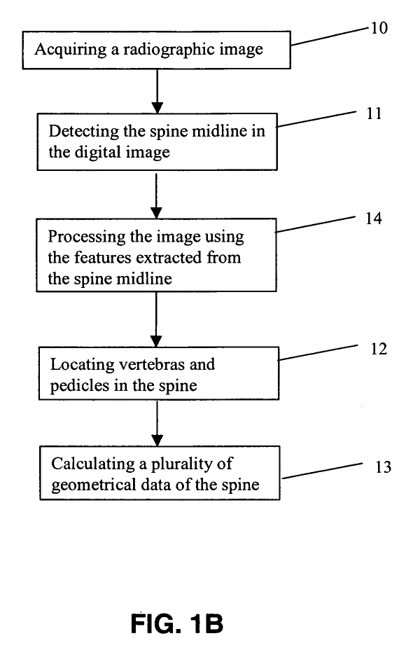

The present invention is directed to a method for automatically analyzing the spine in a radiographic image. That is, detecting the spine, rendering a desired look of the spine in the radiograph, and measuring the spine geometrical data for diagnosis. FIGS. 1A and 1B show flow charts illustrating the automated method in accordance with the present invention.

One embodiment of the method in accordance with the present invention is shown in FIG. 1A. As shown in FIG. 1A, the method includes several steps, including acquiring/accessing a radiographic image in digital form (step 10); detecting the spine midline of the digital image (step 11); locating each vertebra and pedicle in the spine (step 12); and calculating a plurality of geometrical data of the spine (step 13). These steps will be more particularly described below.

In a further embodiment of the present invention, shown in the flow chart of FIG. 1B, an additional step can be accomplished prior to the step of locating vertebra and pedicle (i.e., step 12). This additional step, noted in FIG. 1B as step 14, is the processing of the digital radiographic image according to the features extracted from the spine midline. This step will be more particularly described below.

Referring again to FIGS. 1A and 1B, at step 10, a radiographic image is acquired, and is a digital image form. It can be acquired directly using modalities known to those skilled in the art (for example, computed radiography (CR) or digital radiograph (DR)), or indirectly by means known to those skilled in the art, for example, by the digitization of an analog x-ray film image.

Detecting the Spine Midline

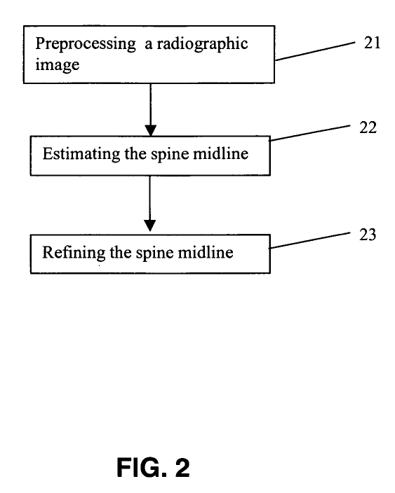

The spine midline is detected at step 11. According to one embodiment of the present invention, the step of detecting the spine midline (step 11) comprises three steps, as shown in FIG. 2. First, the original digital radiographic image is preprocessed (step 21), which includes removing the diagnosis irrelevant regions (e.g., the collimation regions, or the like) in the image and normalizing the image intensity according to the diagnosis relevant regions. Then, a spine midline is estimated from the normalized image or a transformed image computed from the normalized image (step 22). Afterwhich, based on the spine midline estimation, a region of interest (ROI) is determined and used to refine the spine midline (step 23).

Removing the diagnosis irrelevant regions from the image in step 21 can be accomplished using methods known to those skilled in the art. One known method which can be employed is disclosed in U.S. Application Publication No. 2005/0018893 (Wang), entitled METHOD OF SEGMENTING A RADIOGRAPHIC IMAGE INTO DIAGNOSTICALLY RELEVENT AND DIANOSTICALLY IRRELEVANT REGIONS, commonly assigned and incorporated herein by reference.

In the present invention, image intensity normalization is performed over the image in order to compensate for difference in exposure densities caused by patient variations and examination conditions. One technique to achieve normalization is to detect minimum and maximum brightness values from the image histogram (preferably computed from pixels in the anatomy region), and then apply a linear or log transfer function to adjust the image brightness into a pre-defined range. Histogram equalization can be further performed on the image to spread out the peaks in the image histogram, so that more details in low-contrast regions in the image can be better shown. Alternatively, other known techniques can be used to provide normalization, such as a tone scale method disclosed in U.S. Pat. No. 5,633,511 (Lee), entitled AUTOMATIC TONE SCALE ADJUSTMENT USING IMAGE ACTIVITY MEAURES, commonly assigned and incorporated herein by reference.

At step 22, the normalized image is used for estimating the spine midline. However, the complex anatomical structures around the spine make it hard to detect the spine midline. One way to solve the problem is to apply a transformation. Such a transformation should help outline the spine and facilitate the detection of the spine midline.

In one embodiment of the present invention, the transformation can be achieved by computing an X direction derivative image, which is obtained by convoluting the input image I(x,y) with the derivative of a normalized Gaussian G(x,y,σ) at a particular scale σ.
Iₙ^{α}(x,y,σ)=Gₙ^{α}(x,y,σ)\textcircled{×}I(x,y)

The normalized Gaussian in two-dimension is given by:

$$G ( x , y , σ ) = \frac{1}{2 π {σ}^{2}} exp ( \frac{- ( {x}^{2} + {y}^{2} )}{2 {σ}^{2}} )$$

where \textcircled{×}denotes convolution and Gₙ^{α}is the n^{th}—order derivative of the Gaussian kernel in the direction α. In accordance with the present invention, α=0° corresponds to the +X direction, and α=90° stands for the +Y direction.

The detection of the spine midline is accomplished by first detecting extremes (ridge/valley) in the derivative image, then finding a starting point near the center of the X direction derivative image, and tracing vertically up and down from the starting point to obtain the entire outline of the spine midline. To avoid tracing outside of the expected regions, a constraint can be applied to terminate the tracing by using the image information and prior knowledge.

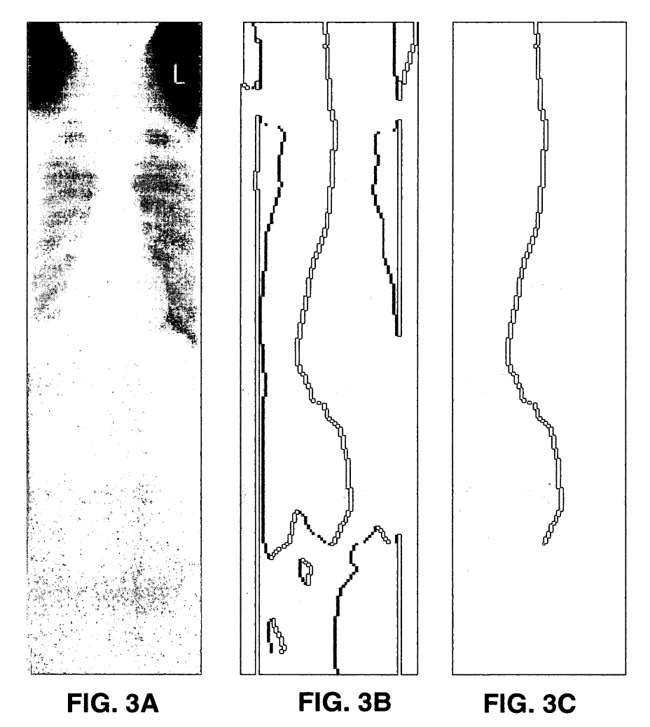

FIG. 3A-3C shows diagrammatic views illustrating the spine midline detection in accordance with the present invention. FIG. 3A shows an exemplary radiograph after preprocess. FIG. 3B depicts the transformed image, i.e. the X-direction derivative image. In the transformed image, a white pixel represents a maximum/ridge in the image, and a black pixel stands for a minimum/valley. As shown in FIG. 3B, the spine middle appears as a spatial ridge in the transformed image. FIG. 3C demonstrates the estimated spine midline using the present method.

It is noted that the present invention is not limited to using the above method to transform the image. An algorithm of similar nature can be employed if it can provide the clear separation of the spine midline from the rest of body part.

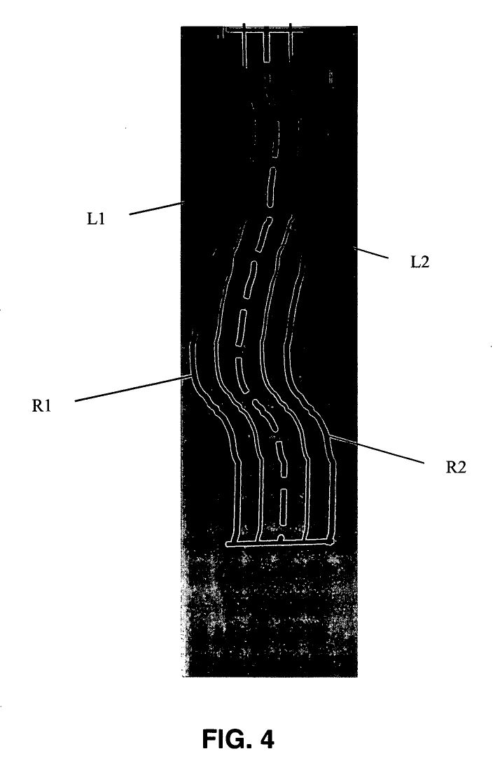

Because of image noise, acquisition conditions, and complex anatomical structures in the image, the detected spine midline may not represent the centerline of the spine accurately. To improve it, a refinement step (step 23) can be performed. In an embodiment of the present invention, a region of interest (ROI) is constructed based on the detected spine midline. FIG. 4 illustrates the construction of the ROI. As shown in FIG. 4, two lines (R1 and R2) are defined on both sides of the estimated spine midline. They are substantially parallel to the estimated spine midline and have a predefined distance with each other. The region enclosed by these two lines is defined as the ROI.

There are several advantage of using the ROI. One advantage is that the image content in the ROI presents preferable features for the spine detection. For example, if the detected spine midline is well located near the center of the spine, the ROI will demonstrate highly symmetry against its centerline. Another advantage is that the ROI constraints the scope of the spine detection, which therefore effectively prevents interferences from ribs and other anatomical structures. Moreover, it limits the image data needed for processing and greatly speeds up the detection process.

Once the ROI is obtained, the spine midline can be refined by incorporating the image data with the prior knowledge.

Referring to FIG. 4, in accordance with one embodiment of the present invention, two lines (L1 and L2) are defined in the ROI. These two lines are placed on each side of the spine midline and allowed to move based on the image data, such as the edge of the image. However, such movement is constrained by a certain conditions, for example the distance between these two lines, and the shape of the lines. If a movement results in the distance between the two lines exceed a predefined range, the movement will be considered to be invalid.

One suitable way to implement such deformation is by using active contour model. Refer, for example, to Kass et al. “Snake: Active contour models” International Journal of Computer vision Vol 1, 1987. According to the model, the two lines move through the spatial domain of an image to minimize the energy functional defined as follows:

$$\begin{matrix}E = {\int }_{0}^{1} E ( v ( s ) ) ⅆ s \\ = {\int }_{0}^{1} {E}_{int} ( v ( s ) ) + {E}_{image} ( v ( s ) ) + {E}_{con} ( v ( s ) ) ⅆ s\end{matrix}$$

where a line is represented as v(s)=[x(s),y(s)], sε[0,1]. By definition, three energies are involved in the deformation. Each of them stands for a force working on the lines.

The internal energy Eᵢₙₜ tries to smooth the lines and avoids the discontinuous shape of the lines. It is given as:
E=(α(s)|vₛ(s)|²−β(s)|vₛₛ(s)|²)/2
where the first-order term controlled by α(s) makes the lines act like a membrane and a second-order term controlled by β(s) makes the lines act like a thin plate. These two terms together impose a piecewise smoothness constraint on the lines.

E_{image} gives rise to the image force pushing the lines toward salient image features. In the present invention, the image feature is defined as the edge of the image, which can be computed by methods known to those skilled in the art.

E_{con} represents the external constraint force responsible for putting the lines within the desired conditions. According to present invention, E_{con} is defined as the distance between the two lines.

During the deformation, the two lines seek a balance between these three forces in the iteration. The deformation is repeated until the movement of the lines is less than a pre-defined threshold from one iteration to the next. Once the deformation is completed, the two lines are expected to be converged at the left and right edge of the spine. With the assistance of the two lines, the spine midline can be located as the center of these two lines.

It is noted that the spine edges can also be detected on the original image, instead of on the ROI. However, this can result in a slow convergence of the spine edge as the complicated bone structures around the spine could oscillate the lines. Moreover, the resulting edges could be distracted by the connecting rib bones.

Processing the Spine Radiograph

As discussed above, a spine radiograph can be generated from two or three radiographs. The dynamic range of intensity in each radiograph can vary due to the various thickness and structures of the anatomy. As a result, the spine can present different appearances at different regions in the stitched image, which can introduce difficulty in diagnosis. Radiologists and orthopedic surgeons prefer to view the whole spine column in a consistent look, i.e., the same brightness and contrast for any region of the spine. This issue can be resolved by using the information provided by the spine midline.

Thus, as indicated at step 14 (shown in FIG. 1B), the image can be processed using features extracted from the spine midline.

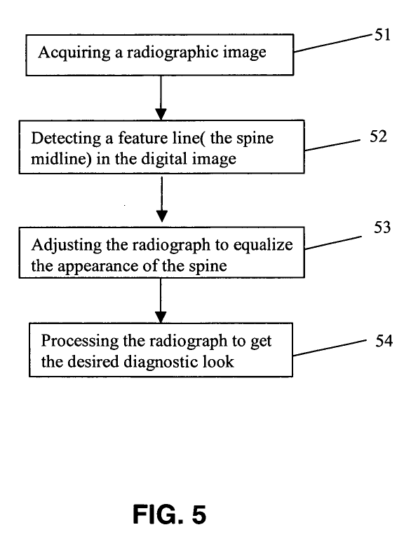

According to one embodiment of the present invention, processing the spine radiograph comprises four steps, as generally shown by the flow diagram in FIG. 5. First, a spine radiographic image is acquired in digital form (step 50). Then, a feature line (i.e., the spine midline) is detected from the image (step 51). The intensity of the radiograph is adjusted to equalize the appearance of the spine (step 53). Finally, the adjusted radiograph is processed (step 54).

In step 53, a profile representing the spine background intensity is extracted from the original image. It is accomplished by calculating an average pixel value within a predefined region on each point along the spine midline. Preferably, a smooth operation is performed on the profile to reduce the noise inference. Based on the profile, a compensation value is derived for each image line, and used to adjust the image intensity along the spine. Accordingly, the spine in the resulting image presents similar intensities. Alternatively, other techniques of similar adjustment nature can be used to equalize the appearance of the spine.

At step 54, the image can be rendered for display and visualization with the methods known in the arts, such as histogram equalization, or the tone scale curve algorithm. For the tone scale curve algorithm, a histogram is constructed from the spine region in the adjusted image. Four points (i.e., the far-left, the left, the right and the far-right point) are identified from the histogram, which are input to optimize a tone scale curve for rendering the desired look of the spine radiograph. The intensities/code values between the left point and the right point correspond the spine, the diagnosis interest region in the image. The far-left point and the far right point are used to roll off both ends (the toe and the shoulder) of the tone scale curve. This can prevent the tone scale curve producing a hard clipping in the rendered image.

It is noted that the present invention can also be extended to other radiographs with similar characteristics, for example the long length images capturing the full legs. Unlike the process of the spine images, the second step will extract one or more features vectors/lines depending on the characteristics of the anatomy in the radiographs. These features represent the anatomy of interest or intensity properties important for image processing/rendering. Then in the third step, an intensity profile or surface is derived from the features to compensate the image intensity. The compensated images are later processed by those skill known in the arts.

The processed radiograph can be sent to display workstation for diagnosis, or a film printer for hardcopy prints.

Locating Vertebra and Pedicle Positions

In the radiographic diagnosis of the spine, accurately detecting the positions of vertebra and pedicles in the spine (step 12 in FIGS. 1A and 1B) is an important step for measuring the spine deformity. However, to develop computerized methods for the vertebra detection is challenging because of the significant variations of vertebra along the spine. For example, the geometries of vertebras are varied from the thoracic vertebra to lumbar vertebra. In addition, the appearance of vertebrae demonstrates different properties due to their surrounding anatomical structures.

According to one embodiment of the present invention, a active shape model (see Cootes et. al, “Active shape models—their training and application,” Computer Vision and Image Understanding, vol. 61, no. 1, 1995) is employed to detect vertebra. An advantage of using active shape model is that it integrates the shape and image data in the segmentation, and it is capable of handling shape variations. The model learns a large variety of vertebras from the training images and saves them into the shape model parameters. During the segmentation, the model automatically adjusts its parameters to best fit the input image and output the optimal segmented results of the vertebra. Since the model combines the knowledge from the previous learning into segmentation, it can provide the correct/suitable contour of the vertebra even when some edges of the vertebra are not visible or overlapped by other anatomical structures.

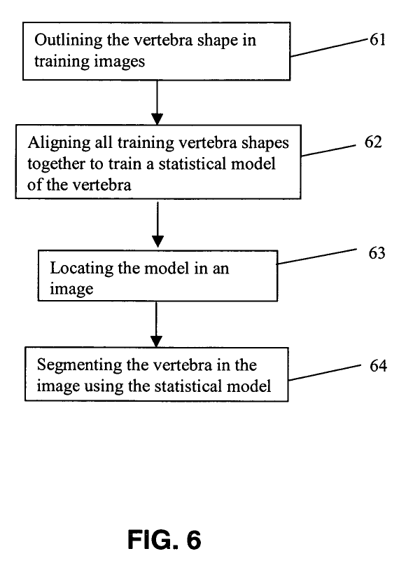

FIG. 6 shows a block diagram generally illustrating the steps of using active shape model for the vertebra detection. The method includes: outlining the vertebra shapes in training images (step 61); aligning all training vertebra shapes together to train a statistical model of the vertebra (step 62); locating the model in an image (step 63); and segmenting the vertebra in the image according to the statistical model (step 64).

In another embodiment of the present invention, the detection of vertebra can be achieved by locating key landmarks of vertebra, rather than detecting the contour of vertebra. These key landmarks specify the positions of the endplate and pedicle in the vertebra. To achieve it, four operations are performed. 1) A new ROI is constructed based on the spine midline. The construction of the ROI is similar to the method mention above. Preferably, the intensity of the ROI is normalized to improve the detection accuracy, which can be done by using methods known to those skilled in the art. 2) The ROI is transformed to outstand the edges of endplates and pedicles. The transformed images could be the edge map of the ROI, the derivative images or the like. 3) A set of feature profiles can be computed from the transformed images to help locate the positions of endplates and pedicles. The feature profiles can be obtained by using the accumulated pixel value of the transformed image along a predefined direction, or more complicatedly, generated by combination of the pixel values from a plurality of transformed images. 4) The position of key landmarks are located by combining the prior knowledge and feature profiles.

Calculating Geometrical Data of the Spine

In step 13 of FIGS. 1A and 1B, a plurality of geometrical data of the spine is calculated. Different measurements can be used for evaluating the geometry of the spine, depending on the diagnostic purpose.

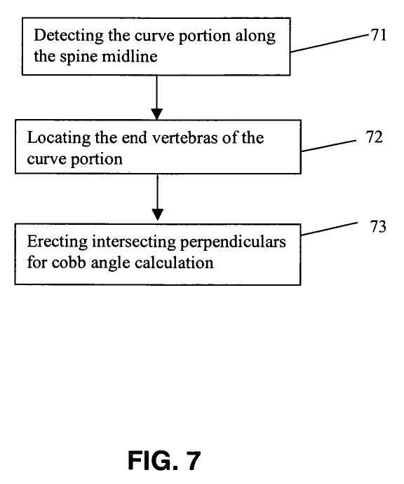

Calculation of the Cobb angle. The Cobb angle method is a commonly used method for measurement of scoliosis. To compute the Cobb angle, the end vertebrae are located. In accordance with an embodiment of the present invention, the end vertebrae is determined by the spine midline. FIG. 7 shows a flow chart illustrating a method for calculating the Cobb angle. It includes three steps: detecting the curve portion along the spine midline (step 71); locating the top and bottom vertebra of the curve portion(step 72); and erecting intersecting perpendiculars for the Cobb angle calculation(step 73).

At step 71, the spine midline is smoothed before the detection, which can be accomplished by those skills in the art. Once the spine midline is smoothed, a curvature is computed for each point on the spine midline. A curve portion of the spine midline can be determined by grouping those points having curvature within a predefined range. Or other suitable algorithms known to those skilled in the art may also be employed to locate the curve portion in the spine midline.

With regard to step 72, the top vertebra can be found at the upper limit of the curve portion. It is the highest vertebra whose superior surface tilts to the side of the concavity of the curve to be measured. The bottom vertebra is the lowest one whose inferior surface tilts to the side of the concavity of the curve to be measured.

Once these vertebrae have been selected, at the step 73, one then draws a line along the upper endplate of the top vertebra and another line along the lower endplate of the bottom vertebra. If the endplates cannot be accurately located, these lines can be drawn along the top and bottom of the pedicles. The Cobb angle is the angle between these two lines, or the perpendicular lines of these two lines.

Calculation of the Ferguson angle. The Ferguson angle is another measurement of scoliosis. It is usually used for curves under 50 degree. Similar to the calculation of Cobb angle, the first steps include detecting the curve portion along the spine midline, and locating two end vertebra of the curve portion. Then, an apex vertebra, the most rotated vertebra at the peak of the curve portion, is located. For each of these three vertebra, its center is determined, and lines are drawn from the apex vertebra to each end vertebra. The angle of the curve is the divergence of these two lines from 180 degree.

It is noted that the present invention is not limited to computing the above geometrical data from the spine. Other measurements, such as the wedge angle of vertebra, the rotation of angle of a vertebra around its axis, or the like, can be calculated by the present invention, because the outlines of the spine, the vertebras and pedicles along the spine are available.

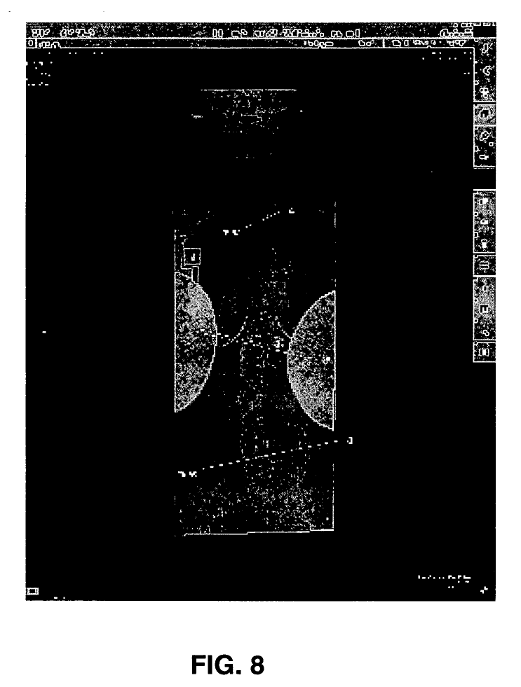

The measurement results can be either displayed as a graphic overlay on the processed or unprocessed spine image, as shown in FIG. 8, or restored as parameters into the spine image headers, e.g. DICOM format. This process can be accomplished at the image acquisition device right after the image is captured, or at the workstation that is used by radiologists or orthopedic surgeons for image review and diagnosis.

If the automatic measurement is accomplished at the capture device, the graphic overlay can be embedded to the image before the image is sent/transmitted to the PACS archive, the clinical/diagnostic review workstation, or a film printer for hardcopy prints. In this situation, it is optional to provide a graphic user interface associated or connected to the capture device to allow the operator for fine adjustment of the graphic overlay.

When the image destination is PACS archive or clinical/diagnostic review workstation, the workstation can interpret the parameters in the spine image header and display them as graphic overlays on the image. Means can be provided by which the radiologists or orthopedic surgeons are able to toggle or select to turn on/off the graphic overlay on the workstation display. Further, the graphic overlay can be adjusted by the user to correct any small errors caused by the automatic measurement method. The final measurement results, either from manual or automatic measurement, can be stored together with the image file at the PACS archive for future retrieval or embedded as a graphic overlay on the image then directly printed to a film from the viewing workstation.

The present invention may be implemented for example in a computer program product. A computer program product may include one or more storage media, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The system of the invention includes a programmable computer having a microprocessor, computer memory, and a computer program stored in said computer memory for performing the steps of the method. The computer has a memory interface operatively connected to the microprocessor. This can be a port, such as a USB port, over a drive that accepts removable memory, or some other device that allows access to camera memory. The system includes a digital camera that has memory that is compatible with the memory interface. A photographic film camera and scanner can be used in place of the digital camera, if desired. A graphical user interface (GUI) and user input unit, such as a mouse and keyboard can be provided as part of the computer.

All documents, patents, journal articles and other materials cited in the present application are hereby incorporated by reference.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### PARTS LIST

10 Acquiring a radiographic image
11 Detecting the spine midline in the digital image
12 Locating vertebras and pedicles in the spine
13 Calculating a plurality of geometrical data of the spine
14 Processing the image using the features extracted from the spine midline
21 Preprocessing a radiographic image
22 Estimating the spine midline
23 Refining the spine midline
51 Acquiring a radiographic image
52 Detecting the spine midline in the digital image
53 Adjusting the radiograph to equalize the appearance of the spine
54 Processing the radiograph to get the desired diagnostic look
61 Outlining the vertebra shape in training images
62 Aligning all training vertebra shapes together to train a statistical model of the vertebra
63 Locating the model in an image
64 Segmenting the vertebra in image using the statistical model
71 Detecting the curve porting along the spine midline
72 Locating the end vertebras of the curve portion
73 Erecting intersecting perpendiculars for Cobb angle calculation

1. A method for analyzing a spine in a radiograph, comprising the steps of:
accessing a digital radiographic image;
detecting a spine midline in the digital radiographic image;
locating vertebras and pedicles in the spine; and
calculating geometrical data of the spine.

2. The method of claim 1, wherein the method further comprises the step of, prior to locating vertebras and pedicles in the spine, processing the digital radiographic image to render a processed digital radiographic image having a desired image look for spine diagnosis, and the steps of locating and calculating are accomplished using the processed digital radiographic image.

3. The method of claim 1, wherein the step of detecting the spine midline in the digital image is accomplished by the steps of:
preprocessing the digital radiographic image;
estimating the spine midline; and
refining the spine midline.

4. The method of claim 3, wherein the step of preprocessing the digital radiographic image is accomplished by the steps of:
removing diagnosis irrelevant regions from the digital radiographic image; and
normalizing image intensity in accordance with the diagnosis relevant regions to generate a normalized image.

5. The method of claim 1, wherein the step of locating vertebras and pedicles in the spine is accomplished by the steps of:
outlining vertebra shapes in a set of training images;
aligning the outlined vertebra shapes to train a statistical model;
mapping the statistical model in the digital radiographic image; and
segmenting the vertebra in the digital radiographic image using the statistical model.

6. The method of claim 1, further comprising the steps of:
using the geometrical data of the spine to generate a spine measurement;
embedding the spine measurement in the digital radiographic image as a graphic overlay to generate an digital spine measurement image; and
displaying, storing, printing, or transmitting the digital spine measurement image.

7. The method of claim 6, further comprising the step of allowing a user to turn on/off the graphic overlap on a display.

8. The method of claim 6, further comprising the step of allowing adjusting the graphic overlay on a display by a user.

9. The method of claim 8, wherein the graphic overlay is adjusted by the user and the adjustment is stored as a parameter associated with the digital radiographic image.

10. The method of claim 1, further comprising the steps of:
using the geometrical data of the spine to generate a spine measurement comprised of at least one parameter;
electronically associating the at least one parameter with the digital radiographic image; and
displaying, storing, printing, or transmitting the digital radiographic image with associated parameter.

11. The method of claim 10, further comprising the step of:
re-generating the spine measurement using the parameter associated with the digital radiographic image;
displaying the digital radiographic image; and
displaying the re-generated measurement as a graphic overlay on the displayed digital radiographic image.

12. A method for processing a spine radiograph, comprising the steps of:
accessing a digital radiographic image;
detecting the spine midline in the digital radiographic image;
adjusting the brightness and contrast of the digital radiographic image to equalize the appearance of the spine; and
processing the radiograph to get the desired diagnostic look.

13. A method for analyzing a spine in a radiograph, comprising the steps of:
accessing a digital radiographic image;
automatically detecting a spine midline in the digital radiographic image by: (1) preprocessing the digital radiographic image by (a) removing diagnosis irrelevant regions from the digital radiographic image, and (b) normalizing image intensity in accordance with the diagnosis relevant regions to generate a normalized image; (2) estimating the spine midline; and (3) refining the spine midline;
processing the digital radiographic image to adjust the intensity of the digital radiographic image;
locating vertebras and pedicles in the spine using active shape modeling;
calculating geometrical data of the spine;
using the geometrical data to generate a spine measurement; and
displaying, storing, printing, or transmitting the spine measurement.

14. The method of claim 13, further comprising the steps of:
embedding the spine measurement in the digital radiographic image as a graphic overlay to generate an digital spine measurement image; and
displaying, storing, printing, or transmitting the digital spine measurement image.

15. The method of claim 14, further comprising the step of allowing a user to turn on/off the graphic overlap on a display.

16. The method of claim 14, further comprising the step of allowing adjusting the graphic overlay on a display by a user.

17. The method of claim 16, wherein the graphic overlay is adjusted by the user and the adjustment is stored as a parameter associated with the digital radiographic image.

18. The method of claim 13, further comprising the steps of:
using the geometrical data of the spine to generate a spine measurement comprised of at least one parameter;
electronically associating the at least one parameter with the digital radiographic image; and
displaying, storing, printing, or transmitting the digital radiographic image with associated parameter.

19. The method of claim 18, further comprising the step of:
re-generating the spine measurement using the parameter associated with the digital radiographic image;
displaying the digital radiographic image; and
displaying the re-generated measurement as a graphic overlay on the displayed digital radiographic image.

20. A method for processing a radiograph, comprising the steps of:
accessing a digital radiographic image;
detecting features of anatomy in the digital radiographic image;
adjusting the brightness and contrast of the digital radiographic image based on the detected features to equalize the appearance of the anatomy; and
processing the radiographic image to produce a desired diagnostic look.
